(19) United States
(12) Patent Application Publication
(10) Pub. No.: US 2023/0206115 A1
(43) Pub. Date: Jun. 29, 2023

(54) EFFICIENT SEMI-AUTOMATIC UNIT TESTING OF VERY LARGE MACHINE MODELS

(71) Applicant: Dell Products L.P., Round Rock, TX (US)

(72) Inventors: Paulo Abelha Ferreira, Rio de Janeiro (BR); Vinicius Michel Gottin, Rio de Janeiro (BR)

(21) Appl. No.: 17/646,015

(22) Filed: Dec. 27, 2021

(51) Int. Cl. G06N 20/00

(52) U.S. Cl. CPC G06N 20/00

(57) ABSTRACT

Testing very large machine models is disclosed. A framework is provided that allows changes to very large machine learning models to be evaluated using compressed machine learning models and automatic or semi-automatic unit testing.

### FIELD OF THE INVENTION

Embodiments of the present invention generally relate to machine learning models and to testing machine learning models, including very large machine learning models. More particularly, at least some embodiments of the invention relate to systems, hardware, software, computer-readable media, and methods for testing very large machine learning models.

### BACKGROUND

Machine learning models are examples of applications that become more accurate in generating predictions without being specifically programmed to generate the predictions. There are different manners in which machine learning models learn. Examples of learning include supervised learning, unsupervised learning, semi-supervised learning and reinforcement learning.

Generally, a machine learning model is trained with certain types of data. The data may depend on the application. Once trained or once the machine learning model has learned from the training data, the machine learning model is prepared to generate predictions using real data.

Training a machine learning model, however, can be costly. This is particularly true for certain machine learning models such as VLMs (Very Large Models). VLMs may have, for example, on the order of a trillion parameters. As a result, training and testing VLMs can be costly from both economic and time perspectives.

These VLM training and testing difficulties can present problems whenever a change is made to anything associated with the operation of the VLM. If a change is made to the dataset, the model pipeline, or the codebase, there is a need to ensure that the VLM remains valid. In fact, there are many instances where it is critical to have quality and performance guarantees, such as in self-driving vehicles. Accordingly, example embodiments disclosed herein address issues associated with retraining and retesting VLMs while minimizing costs and ensuring that changes surrounding the VLMs do not adversely impact the behavior of the VLMs.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of automatic or semi-automatic unit testing of very large machine learning models;

FIG. 2 discloses aspects of testing very large machine learning models;

FIG. 3 discloses aspects of a computing device or a computing system.

### DETAILED DESCRIPTION OF SOME EXAMPLE EMBODIMENTS

Embodiments of the present invention generally relate to machine learning models including very large machine learning models (VLMs), referred to generally herein as models. More particularly, at least some embodiments of the invention relate to systems, hardware, software, computer-readable media, and methods for unit testing of very large machine learning models.

Model management relates to managing models and ensures that the models meet expectations and business requirements. Model management also ensures that models are properly stored, retrieved, delivered in an up-to-date state, and the like. Embodiments of the invention relate to increasing quality assurance when a change or changes are made to a model pipeline, model datasets, model codebase, or the like. Embodiments of the invention are able to retrain and/or retest a model while reducing or minimizing costs.

Retraining and/or retesting models such as VLMs can be cost prohibitive and embodiments of the invention ensure that, when a change that may impact the behavior of a model occurs, the training and validation behavior remains the same or sufficiently close to the expected behaviors of the model prior to the change. In order to retrain and/or retest in a more cost-effective manner, embodiments of the invention may generate a small or proxy version of a model using compression, such as neural network compression. Embodiments of the invention may perform unit testing on compressed models.

A framework is provided that allows specific tests to be created for a given functionality of a model such as a VLM. For example, a test for the expected final training error or the expected validation error curve may be created. These tests are executed using the proxy or compressed versions of the models. Embodiments of the invention relate to unit testing and neural network compression in a single framework.

Aspects (e.g., functionality, behavior, metrics) of models can be tested using unit tests. A unit test, which may be automated, helps ensure that a particular unit of code or other aspect of a model is performing the desired behavior. The unit of code being tested may be a small module of code or relate to a single function or procedure. In some examples, unit tests may be written in advance.

Model compression allows a compact version of a model to be generated. Compression is often achieved by decreasing the resolution of a model's weights or by pruning parameters. Embodiments of the invention ensure that the compressed model is small and achieves similar performance on selected metrics with respect to the original uncompressed model. The compressed models may be, by way of example only, 10%-20% of the size of the original models while still achieving comparable metrics.

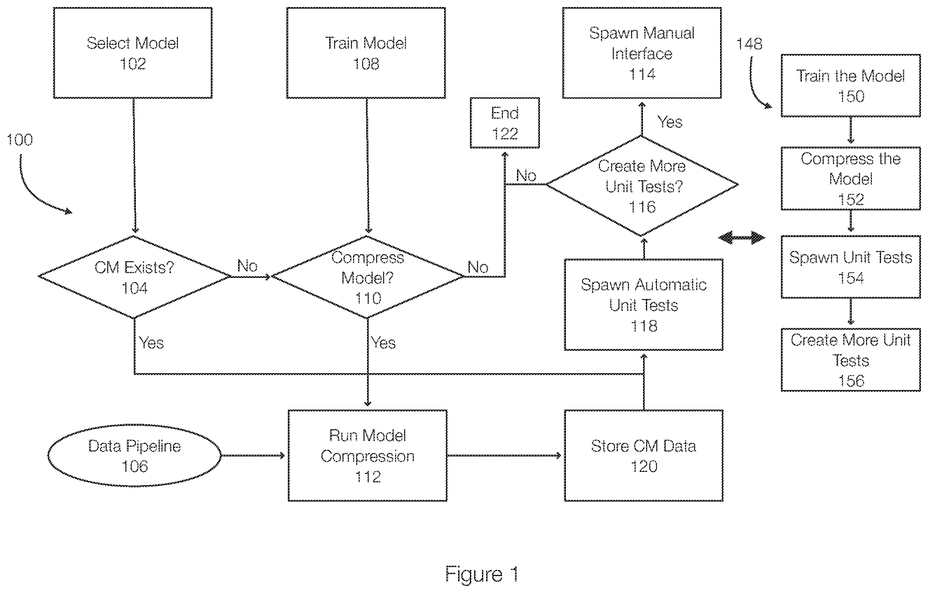

FIG. 1 discloses aspects of a framework for managing models. FIG. 1 presents a method 100 performed in a framework that allows models to be tested more aeffectively. The framework generally executes unit tests on compressed models (CMs), which are generated by compressing the corresponding models. The CMs are examples of proxy versions of the original VLMs. Embodiments of the invention are capable of testing multiple models independently and simultaneously using corresponding compressed models.

The method 100 may begin in different manners. For example, the method 100 may begin by selecting 102 a model that has already been trained. If a compressed model (CM) for the selected model exists (Yes at 104), the method may spawn 118 automatic unit tests. Spawning tests 118 may include recommending tests for execution. These tests may have been developed in advance and may be automatically associated with the CM.

If the CM does not exist (No at 104), the model may be compressed 110. If the model is not compressed, the method ends 122. If a compressed model is generated (Yes at 110), the compressed model is run or executed 112 using a data pipeline 106. Metadata generated from running the compressed model is stored 120 and unit tests may be created or spawned 118.

Another starting point is to train 108 a model and then compress (Yes at 110) the model. If the model is not compressed, (No at 110), the method may end 122. If there is a need to compress 110 the model that has been trained 108 (Yes at 110), a compression model is run 112 based on data from a data pipeline 106. The output of the compression model is stored 120 as CM metadata and automatic unit tests are spawned 118.

Training 108 a model, particularly a very large model, may require access to large amounts of storage and multiple processors or accelerators. Training the model may require days or weeks, depending on the resources. Because of the time required to train the model or for other reasons, embodiments of the invention may store metadata associated with training the model. The metadata generated and/or stored may include, but is not limited to, training/validation loss evolution, edge cases with bad prediction, timestamps for waypoints along training/validation, or the like. These metadata can be used for various automatic unit tests. More specifically, the unit test may generate or be associated with metadata that can be compared to the metadata generated during training.

As previously stated, compressing a model into a CM is performed and metadata associated with training and validating the CM are stored. Embodiments of the invention do not require the CM to achieve the same level of accuracy or other metric as the original model. Rather, the CM serves as a valid proxy when the metric or other output is reasonable. Reasonable may be defined by a threshold value or percentage. Further the assessment of the metric or output can be based on hard (exact) or soft (withing a threshold deviation) standards.

Embodiments of the invention may rely on the relationship between the metadata gathered or generated by the CM and the metadata gathered or generated by the original model. When running a unit test, the current training or validation data or metrics (metadata) generated by the running or executing the CM with the change may be compared to the metadata stored in association with the model prior to the change.

Regardless of the starting point of the method 100 (selecting 102 or training 108 a model), once a CM is associated with a model and metadata for the CM has been generated, a series of automatic unit tests can be created or spawned 118. These unit tests may assert a hard or soft comparison between the metadata of the stored CM with the metadata of the CM based on the modified code base.

In addition, embodiments of the invention allow a user to create 116 additional unit tests, for example via a manual interface 114. These unit tests can be based on any metadata related to the CMs and may be created to address cases or situations that are not covered by the automatically generated unit tests.

In general, the method 100 may be represented more compactly by the method 148 performed in a framework 100. The method 148 may include training/selecting 150 a model. The trained/selected model is compressed 152 to generate a compressed model. In one example, the trained/selected model may already be associated with a compressed model and the compressed model does not need to be generated. Unit tests can be created or spawned 154 for the compressed model. Additional unit tests can be created 156 for the compressed model.

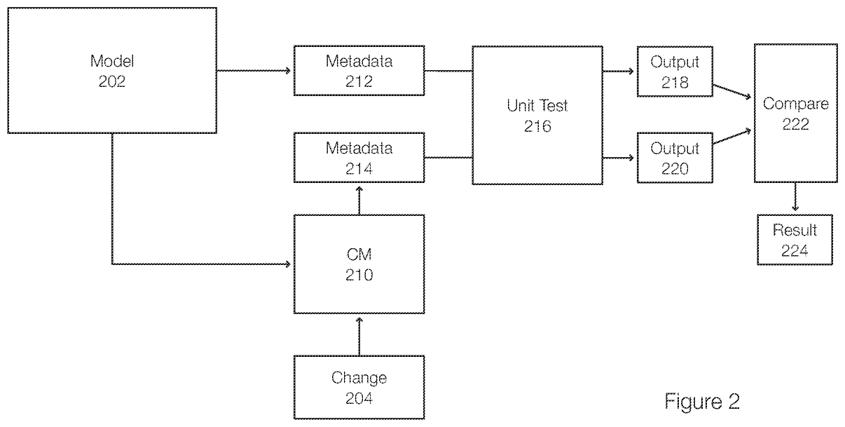

FIG. 2 discloses aspects of unit tests and unit testing. Unit tests can vary widely in function and purpose and the following discussion provides a few examples. Embodiments of the invention are not limited to these examples. FIG. 2 illustrates a model 202. The CM 210 is generated by compressing model 202. Metadata 212 is generated from operation and/or training of the model 202.

Whenever there is a change that impacts the model 202, it may be necessary to determine whether the behavior or other aspect of the model 202 is affected. In this example, the model 202 is impacted by or associated with a change 204. The change 204 may be a change to the training data or other data set, the codebase of or used by the model 202, the pipeline or the like. The metadata 214 is generated from operation of the CM 210.

The unit test 216 can be performed separately or independently on the metadata 212 and the metadata 214. Thus, the unit test 216 generates an output 218 from the metadata 212 and the unit test 216 generates an output 220 from the metadata 214. The output 218 and 220 are compared 222 to generate a result 224. The result 224 may indicate whether the model 202 is operating as expected or whether any change in behavior is acceptable in light of the change 204. Stated differently, the result 224 may indicate that the behavior, prediction, or other aspect of the model 202 is operating properly or valid for the aspect of the model 202 tested by the unit test 216.

As illustrated in FIG. 2, the impact of the change 204 on the model 202 is evaluated by generating the metadata 214 using the CM 210 in the context of the change 204. In other words, the CM 210 run and the metadata 214 reflects the change 204, which may be to the training data or other data set, codebase, or model pipeline.

Embodiments of the invention allow the behavior of the model 202 to be evaluated based on unit tests that are applied to the CM 210. More specifically, the behavior of the model 202 can be compared to the behavior of the CM 210. The behavior of the CM 210, which is operated in the context of the change 204, allows the impact of the change 204 on the model 202 to be determined and to determine whether the behavior of the model 202 will be acceptable in light of the change 204.

As previously stated, unit tests may be generated automatically. Once a CM is generated, unit tests can be automatically associated with the CM. This is one way to identify which unit tests should be performed in the event of the change 204. Further, unit tests can be suggested (e.g., based on actions of other users or based on unit tests for similar models) to the user. Unit tests may also be created.

Unit tests can be created to test different functions, metrics, or other aspects of models and may be specific to changes or to the type of the change. Thus, changes impacting the codebase may be performed with specific metadata or metrics related to the part of the codebase that was changed. Unit testing is often used in test-driven machine learning development. This allows tests to be written in order to detect changes to intended behavior. This allows for development to be performed rapidly.

In the context of very large machine models, automatic unit testing using CMs overcomes the problem of having to test the actual model. Unit tests can be generated based on generic algorithms, based on feedback, or the like.

For example, the unit test 216 may be an inner model metric unit test. In this case, the unit test attempts to measure deviation from established inner model metrics. For a given dataset (or portion thereof), for example, a certain final state or behavior may be expected. The metric can involve a single hidden layer, two or more hidden layers, interactions between those layers, or the like.

When the output 220 (for the CM 210 with the change 204) is sufficiently close or equal to the output 218 (for the model 202 without the change), then the test may be a success. More specifically, the unit test is performed on metadata 214 generated by the compressed model 210 rather than the model 202 itself because, as previously stated, testing very large machine models takes substantial time and/or cost. Thus, the output 220 is associated with the compressed model 210 and gives an indication of how the change 204 impacted the original model 202.

If the deviation (e.g., difference between the output 220 and the output 218) is sufficiently small or within a threshold (e.g., 1%, 2%, 3%, 4%, 5%, 6%, 7%, 8%, 9%, 10%, or other value), the test may be a success. In this example, the metadata associated with an inner model metric unit test may include values pertaining to hidden layers of the model/CMs in relation to a given dataset or portion thereof. These metadata serve to assert the expected behavior of the model with respect to a given set of input samples and allow the functionality of the model 202 to be tested using the CM 210 that is operated in the context of the change 204.

In another example, the unit test 216 may be an output metric unit test. Output metric unit tests are configured to compare the output 218 (e.g., a prediction or inference) associated with the model 202 with the output 220 associated with the CM 210. The output metric unit test is thus configured to determine the impact of a change to the codebase (e.g., data processing, pipeline code changes). In this example, the changes to the codebase do not affect the input entering the CM 210. If the CM is deterministic, then the outputs 218 and 220 can be compared. More specifically, the output metric unit test may perform a soft comparison as changes to the dataset or output may be expected. In one example, only minor changes are expected. Thus, a threshold between the outputs 218 and 220 can be determined. In this example, the metadata 212 and 214 may include values output by the CM with respect to a given dataset or set of datasets thereof. If a soft comparison is performed, the unit test may be successful if the deviation or difference is within a threshold or is acceptable to a user.

The unit test 216 may be an evolution metric unit test. This type of unit test is configured to compare the evolution of a given metric across an interval of time or steps, such as the validation loss curve. The metadata may include values related to the evolution of one or more metrics across time, such as for training, validation, or the like.

The change 204 may include changes to the model pipeline, datasets, or codebase. For example, datasets used in machine models undergo processing. The change 204 may be related to data ETL (Extract-Transform-Load). This is a process of moving and transforming data from an environment where the data is stored to a volume where it can be used, such as by a machine learning model. This may include feature extraction, parameter related processing, or the like. Any modification to the ETL process (e.g., the change 204) may affect the behavior of the model 202. As a result, unit tests may be created to determine whether changes to the ETL in the context of the CMs have affected the behavior of the original model. Thus, the impact of the ETL changes on the model 202 can be determined based on the output 220 using the metadata 214 of the CM 210.

The change 204 may relate to library updates or rollbacks. When there is a modification to a library used to process or model a codebase (e.g., Machine Learning framework libraries), it is useful to test for the expected behavior of the model based on how these changes relate to how the model is trained, runs, or is stored.

The change 204 may relate to hardware changes. Modifications to the hardware (e.g., CPU (Central Processing Unit)/GPU (Graphical Processing Unit) version) running the model may impact the behavior of the model. It may be useful to ensure that these changes do not change or only minimally change (within a threshold) the expected behavior.

As previously suggested unit tests can be performed to ensure that expected behavior does not change or that the behaviors do not deviate from expected behavior by more than a threshold. Embodiments of the invention integrate model compression and unit testing in the same framework.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing platforms, examples of which include the Dell-EMC NetWorker and Avamar platforms and associated backup software, and storage environments such as the Dell-EMC DataDomain storage environment. In general however, the scope of the invention is not limited to any particular data platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, VMs, containers, or any combination of these, though no particular device implementation or configuration is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

It is noted with respect to the example methods of FIGS. 1 and 2 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: generating metadata from a machine learning model, generating metadata from a compressed machine learning model, wherein the compressed machine learning model corresponds to the model, comparing the metadata from the model with the metadata from the compressed machine learning model, and determining whether a behavior of the compressed machine learning model is within a threshold value based on the comparison.

Embodiment 2. The method of embodiment 1, further comprising automatically generating unit tests, wherein comparing the metadata from the machine learning model and the metadata from the compressed machine learning model comprises performing the unit tests on the metadata from the machine learning model and the metadata from the compressed machine learning model.

Embodiment 3. The method of embodiment 1 and/or 2, wherein the unit tests include inner model metric unit tests, output metric unit tests, and/or evolution metric unit tests.

Embodiment 4. The method of claim 1, further comprising generating metadata from the compressed machine learning model upon detection of a change and determining whether a behavior of the model is still valid using the metadata from the compressed machine learning model.

Embodiment 5. The method of embodiment 1, 2, 3, and/or 4, wherein the change is at least one of a data ETL (Extract-Transform-Load) change, a library update, a library rollback, a codebase change, a hardware change, a pipeline change, a dataset change or combination thereof.

Embodiment 6. The method of embodiment 1, 2, 3, 4, and/or 5, further acomprising generating metadata for a second machine learning model and metadata for a second compressed machine learning model corresponding to the second model.

Embodiment 7. The method of embodiment 1, 2, 3, 4, 5, and/or 6, further comprising compressing the machine learning model.

Embodiment 8. The method of embodiment 1, 2, 3, 4, 5, 6, and/or 7, further comprising recommending additional unit tests and presenting a user interface that allows more additional unit tests to be created.

Embodiment 9. The method of embodiment 1, 2, 3, 4, 5, 6, 7, and/or 8, wherein determining whether a behavior of the compressed machine learning model is within a threshold value further comprises determining whether a behavior of the model is within the threshold.

Embodiment 10. The method of embodiment 1, 2, 3, 4, 5, 6, 7, 8, and/or 9, wherein each of the unit tests is a soft unit test or a hard unit test, wherein the unit tests are configured to detect a deviation in behavior.

Embodiment 11. The method of embodiment 1, 2, 3, 4, 5, 6, 7, 8, 9, and/or 10, wherein the machine learning model is a very large machine learning model.

Embodiment 12. A method for performing any of the operations, methods, or processes, or any portion of any of these, or any combination thereof disclosed herein.

Embodiment 13. A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ or ‘engine’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

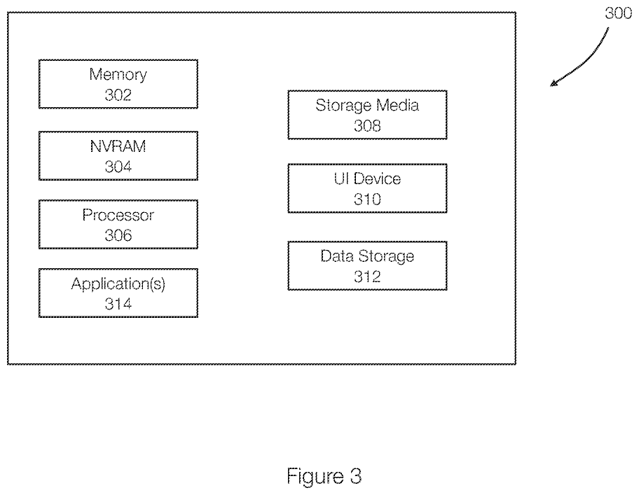

With reference briefly now to FIG. 3, any one or more of the entities disclosed, or implied, by the Figures and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 (or computing system) includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
generating metadata from a machine learning model;
generating metadata from a compressed machine learning model, wherein the compressed machine learning model corresponds to the model;
comparing the metadata from the model with the metadata from the compressed machine learning model; and
determining whether a behavior of the compressed machine learning model is within a threshold value based on the comparison.

2. The method of claim 1, further comprising automatically generating unit tests, wherein comparing the metadata from the machine learning model and the metadata from the compressed machine learning model comprises performing the unit tests on the metadata from the machine learning model and the metadata from the compressed machine learning model.

3. The method of claim 2, wherein the unit tests include inner model metric unit tests, output metric unit tests, and/or evolution metric unit tests.

4. The method of claim 1, further comprising generating metadata from the compressed machine learning model upon detection of a change and determining whether a behavior of the model is still valid using the metadata from the compressed machine learning model.

5. The method of claim 4, wherein the change is at least one of a data ETL (Extract-Transform-Load) change, a library update, a library rollback, a codebase change, a hardware change, a pipeline change, a dataset change or combination thereof.

6. The method of claim 1, further comprising generating metadata for a second machine learning model and metadata for a second compressed machine learning model corresponding to the second model.

7. The method of claim 1, further comprising compressing the machine learning model.

8. The method of claim 1, further comprising recommending additional unit tests and presenting a user interface that allows more additional unit tests to be created.

9. The method of claim 1, wherein determining whether a behavior of the compressed machine learning model is within a threshold value further comprises determining whether a behavior of the model is within the threshold.

10. The method of claim 2, wherein each of the unit tests is a soft unit test or a hard unit test, wherein the unit tests are configured to detect a deviation in behavior.

11. The method of claim 1, wherein the machine learning model is a very large machine learning model.

12. A non-transitory storage medium having stored therein instructions that are executable by one or more hardware processors to perform operations comprising:
generating metadata from a machine learning model;
generating metadata from a compressed machine learning model, wherein the compressed machine learning model corresponds to the model;
comparing the metadata from the model with the metadata from the compressed machine learning model; and
determining whether a behavior of the compressed machine learning model is within a threshold value based on the comparison.

13. The non-transitory storage medium of claim 12, further comprising automatically generating unit tests, wherein comparing the metadata from the machine learning model and the metadata from the compressed machine learning model comprises performing the unit tests on the metadata from the machine learning model and the metadata from the compressed machine learning model.

14. The non-transitory storage medium of claim 13, wherein the unit tests include inner model metric unit tests, output metric unit tests, and/or evolution metric

15. The non-transitory storage medium of claim 12, further comprising generating metadata from the compressed machine learning model upon detection of a change and determining whether a behavior of the model is still valid using the metadata from the compressed machine learning model.

16. The non-transitory storage medium of claim 15, wherein the change is at least one of a data ETL change, a library update, a library rollback, a codebase change, a hardware change, a pipeline change, a dataset change or combination thereof.

17. The non-transitory storage medium of claim 12, further comprising generating metadata for a second machine learning model and metadata for a second compressed machine learning model corresponding to the second model.

18. The non-transitory storage medium of claim 12, further comprising recommending additional unit tests and presenting a user interface that allows more additional unit tests to be created.

19. The non-transitory storage medium of claim 12, wherein determining whether a behavior of the compressed machine learning model is within a threshold value further comprises determining whether a behavior of the model is within the threshold.

20. The non-transitory storage medium of claim 12, wherein each of the unit tests is a soft unit test or a hard unit test, wherein the unit tests are configured to detect a deviation in behavior, wherein the machine learning model is a very large machine learning model.
